(19) United States
(12) Patent Application Publication
(10) Pub. No.: US 2009/0286905 A1
(43) Pub. Date: Nov. 19, 2009

(54) Toughened Blends of Cellulose Esters with Polyacetals

(75) Inventors: Edmund Arthur Flexman, Wilmington, DE (US); Ramabhadra Ratnagiri, Wilmington (IN)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/467,651

(22) Filed: May 18, 2009

Related U.S. Application Data
(60) Provisional application No. 61/128,138, filed on May 19, 2008.

(51) Int. Cl. C08L 1/10

(52) U.S. Cl. 524/37

(57) ABSTRACT

Thermoplastic compositions comprising (a) 87 to 30 weight percent of polyacetal homopolymer, copolymer, or a combination of these; (b) 10 to 60 wt % of one or more cellulose ester(s) of C1 to C6 alkyl carboxylic acids; and (c) 3-15 wt % of at least one toughener

### CROSS-REFERENCE TO RELATED APPLICATIONS

This application claims the benefit of priority from U.S. Prov. App. No. 61128138, filed 19 May 2008 and currently pending.

### FIELD OF INVENTION

The invention recited in the claims relates to toughened polyoxymethylene thermoplastic compositions having high heat distortion temperatures.

### BACKGROUND OF THE INVENTION

Polyacetals, also known in the art as polyoxymethylene, are known to have excellent tribology and good physical properties, such as heat distortion temperature (HDT), important to maintaining the functioning of parts at elevated temperatures. For that reason, using materials miscible with polyacetals results in blends having improved, that is, higher, heat distortion temperature and advances uses and contexts that profit from high HDT.

U.S. Pat. No. 3,406,130 discloses examples of such blends, specifically cellulose polymer blends comprising polyoxymethylene and cellulose ester from a colloidal dispersion. These blends are moldable.

Still needed are compositions that can be injection- or blow-molded, without the use of liquids, and have improved HDT properties over that of polyoxymethylene.

### SUMMARY OF THE INVENTION

Disclosed herein are thermoplastic compositions and articles made from these, the compositions comprising:
(a) about 87 to about 30 wt % of polyacetal homopolymer, copolymer, or combination thereof;
(b) about 10 to about 60 wt % of one or more cellulose ester(s) of C1 to C6 alkyl carboxylic acids; and
(c) about 3 to about 15 wt % of at least one toughener, wherein (a), (b) and (c) are based on the total weight of said thermoplastic composition.

### DETAILED DESCRIPTION OF THE INVENTION

Described herein are thermoplastic compositions comprising: (a) about 87 to about 30 wt % of polyacetal homopolymer, copolymer, or combination thereof; (b) about 10 to about 60 wt % of one or more cellulose ester(s) of C1 to C6 alkyl carboxylic acids; and (c) about 3 to about 15 wt % of at least one toughener, wherein the wt % of (a), (b) and (c) are based on the total weight of said thermoplastic composition.

### DEFINITIONS

The invention recited in the claims and described herein should be interpreted using the following definitions:

As used herein, the term “wt %” is an abbreviation for weight percent.

As used herein, the term “polyoxymethylene” refers to

(i) homopolymers of formaldehyde or of cyclic oligomers of formaldehyde, the terminal groups of which are end-capped by esterification or etherification; and
(ii) copolymers of formaldehyde or of cyclic oligomers of formaldehyde with oxyalkylene groups with at least two adjacent carbon atoms in the main chain. The terminal groups of the copolymers may be hydroxyl terminated or end-capped by esterification or etherification.

As used herein, the term “long chain ester units” is applied to units in a polymer chain and refers to the reaction product of long chain glycol with a dicarboxylic acid. As used herein, the term “dicarboxylic acid” refers to??

Such “long chain ester units”, which are a repeating unit in the copolyesters, correspond to formula (I) above. The long chain glycols are polymeric glycols having terminal (or as nearly terminal as possible) hydroxyl groups and a molecular weight above about 400 and preferably from about 400-4000. The long chain glycols used to prepare the copolyesters are poly(alkylene oxide) glycols as disclosed herein.

As used herein, the term “short chain ester units” is applied to units in a polymer chain and refers to polymer chain units having molecular weights less than about 550. They are made by reacting a low molecular weight diol (below about 250) with a dicarboxylic acid to form ester units represented by formula (II) above.

The polyoxymethylene polymer described above may be branched or linear. The suitability of polyoxymethylene polymers used in the compositions described herein can be characterized in different ways, for example, by its number average molecular weight, which is in the range of 20,000 to 100,000, preferably 25,000 to 90,000, more preferably 30,000 to 70,000, and most preferably 35,000 to 40,000. The molecular weight of the polyoxymethylene can be conveniently measured by gel permeation chromatography in m-cresol at 160° C. using a Du Pont PSM bimodal column kit with nominal pore size of 60 and 1000 angstrom.

If the molecular weight of the polyoxymethylene polymer is too high, it will be difficult to blend it with the toughener and cellulose ester. If the molecular weight of the polyoxymethylene is too low, its melt viscosity will be low, making it difficult to sufficiently mix the toughener and cellulose ester such that the toughener will be dispersed throughout the composition as discrete particles. This quality of dispersion is important because ????

Instead of characterizing suitability by number average molecular weight, the polyoxymethylene's suitability can alternatively be characterized by its melt flow rate. Polyoxymethylenes suitable in the compositions described herein have a melt flow rate, measured at 190° C., 2.16 Kg load, according to ISO 1133, of 0.1-30 grams/10 minutes. Preferably, the melt flow rate of the polyoxymethylene used herein ranges from 0.1 grams/10 minutes to 10 grams/10 minutes.

Polyoxymethylene Copolymer

As indicated above, the polyoxymethylene may be a homopolymer, a copolymer, and a combination of these. When the polyoxymethylene includes a copolymer, preferred are copolymers of formaldehyde and ethylene oxide where the quantity of ethylene oxide is about 2 weight percent.

Copolymers described herein may contain one or more comonomers generally used in preparing polyoxymethylene compositions. The quantity of the constituent comonomer is not more than 20 weight percent, preferably not more than 15 weight percent, and most preferably about 2 weight percent. More commonly used comonomers include alkylene oxides of 2-12 carbon atoms. The most preferred comonomer is ethylene oxide.

Polyoxymethylene Homopolymer

Generally, polyoxymethylene homopolymer is preferable over copolymer because of its greater stiffness. Homopolymers for use in the compositions described herein are most preferably those with a number average molecular weight of about 38,000 and those having terminal hydroxyl groups end-capped by a chemical reaction to form ester or ether groups, preferably acetate or methoxy groups, respectively.

Tougheners

Tougheners useful in the compositions described herein are thermoplastic elastomers having a soft segment glass transition temperature of less than −20° C. and ethylene copolymers, which can include three or more monomers. Preferred thermoplastic elastomers are selected from the group consisting of thermoplastic polyurethanes, copolyetheramides, and copolyetheresters.

Suitable thermoplastic polyurethane elastomers may be selected from those commercially available or made by processes known in the art. See, for example, Rubber Technology, 2nd edition, edited by Maurice Morton (1973), Chapter 17, Urethane Elastomers, D. A. Meyer, especially pp. 453-6.

Thermoplastic polyurethane elastomers derive from the reaction of polyester or polyether diols with diisocyanates and optionally also from the further reaction of such components with chain-extending agents such as low molecular weight polyols, preferably diols, or with diamines to form urea linkages. Thermoplastic polyurethane elastomers are generally composed of soft segments, for example polyether or polyester polyols, and hard segments, usually derived from the reaction of low molecular weight diols and diisocyanates. Although thermoplastic polyurethane elastomers without hard segments may be used to prepare compositions described herein, most useful of these elastomers have both soft and hard segments.

In the preparation of thermoplastic polyurethane elastomers suitable herein, a polymeric soft segment material having at least two hydroxyl groups per molecule and having a molecular weight of at least about 200 and preferably from about 550 to about 5,000 and most preferably from about 1,000 to about 2,500, such as a dihydric polyester or a poly(alkylene oxide)glycol, is reacted with an organic diisocyanate in a ratio such that a substantially linear polyurethane polymer results, although some branching can be present. A diol chain extender having a molecular weight less than about 250 may also be incorporated. The mole ratio of isocyanate to hydroxyl in the polymer is preferably from about 0.95 to 1.08, more preferably 0.95 to 1.05, and most preferably, 0.95 to 1.02. In addition, monofunctional isocyanates or alcohols can be used to control molecular weight of the polyurethane.

As pointed out above, thermoplastic polyurethane elastomers derive from the reaction of polyester or polyether diols with diisocyanates. As for the first named polyurethane constituent, suitable polyester polyols include polyesterification products of one or more dihydric alcohols with one or more dicarboxylic acids. Other suitable polyester polyols are derived from a combination of dihydric alcohols and mono acid alcohols, such as caproic acid and caprolactone. Suitable dicarboxylic acids include adipic acid, succinic acid, sebacic acid, suberic acid, methyladipic acid, glutaric acid, pimelic acid, azelaic acid, thiodipropionic acid and citraconic acid and combinations thereof including small amounts of aromatic dicarboxylic acids. Suitable dihydric alcohols include ethylene glycol, 1,3- or 1,2-propylene glycol, 1,4-butanediol, 1,3-butanediol, 2-methyl pentane diol-1,5, diethylene glycol, 1,5-pentanediol, 1,6-hexanediol, 1,12-dodecanediol and combinations thereof. Besides these, hydroxycarboxylic acids, lactones and cyclic carbonates, such as ε-caprolactone and 3-hydroxybutyric acid may also be used in the preparation of the polyester.

Preferred polyesters include poly(ethylene adipate), poly(1,4-butylene adipate), mixtures of these adipates and poly ε-caprolactone. Suitable poly(alkylene oxide)glycols include the condensation products of one or more alkylene oxides with a small amount of one or more compounds having active hydrogen-containing groups, such as water, ethylene glycol, 1,2- or 1,3-propylene glycol, 1,4-butanediol and 1,5-pentanediol, and mixtures thereof. Suitable alkylene oxide condensates include those of ethylene oxide, 1,2-propylene oxide and butylene oxide and combinations thereof. Suitable poly(alkylene oxide)glycols may also be prepared from tetrahydrofuran. In addition, suitable polyether polyols can contain comonomers, especially as random or block comonomers, ether glycols derived from ethylene oxide, propylene oxide and/or tetrahydrofuran (THF). Alternatively, a THF polyether copolymer with minor amounts of 3-methyl THF can also be used.

Preferred poly(alkylene oxide)glycols include poly(tetramethylene ether) glycol (PTMEG), poly(1,2-propylene oxide) glycol, poly(1,3-propylene oxide) glycol, copolymers of propylene oxide and ethylene oxide, and copolymers of tetrahydrofuran and ethylene oxide. Other suitable polymeric diols include those which are primarily hydrocarbon in nature, e.g., polybutadiene diol. The number-average molecular weight of the poly(alkylene oxide)glycol is preferably 200-6,000, more preferably 250-4,000, as measured by gel permeation chromatography.

As for the second named polyurethane constituent, suitable organic diisocyanates include 1,4-butylene diisocyanate, 1,6-hexamethylene diisocyanate, cyclopentylene-1,3-diisocyanate, 4,4″-dicyclohexylmethane diisocyanate, isophorone diisocyanate, cyclohexylene-1,4-diisocyanate, 2,4-tolylene diisocyanate, 2,6-tolylene diisocyanate, isomeric mixtures of 2,4- and 2,6-tolylene diisocyanate, 4,4″-methylene bis(phenylisocyanate), 2,2-diphenylpropane-4,4″-diisocyanate, p-phenylene diisocyanate, m-phenylene diisocyanate, xylylene diisocyanate, 1,4-naphthylene diisocyanate, 1,5-naphthylene diisocyanate, 4,4″-diphenyl diisocyanate, azobenzene-4,4″-diisocyanate, m- or p-tetramethylxylene diisocyanate and 1-chlorobenzene-2,4-diisocyanate. 4,4″-Methylene bis(phenylisocyanate), 1,6-hexamethylene diisocyanate, 4,4″-dicyclohexylmethane diisocyanate and 2,4-tolylene diisocyanate are preferred.

Secondary amide linkages including those derived from adipyl chloride and piperazine, and secondary urethane linkages, including those derived from the bis-chloroformates of PTMEG and/or butanediol, can also be present in the thermoplastic polyurethane elastomers used herein.

Dihydric alcohols suitable for use as chain extending agents in the preparation of thermoplastic polyurethane elastomers used herein include those containing carbon chains which are either uninterrupted or which are interrupted by oxygen or sulfur linkages, including 1,2-ethanediol, 1,2-propanediol, isopropyl-a-glyceryl ether, 1,3-propanediol, 1,3-butanediol, 2,2-dimethyl-1,3-propanediol, 2,2-diethyl-1,3-propanediol, 2-ethyl-2-butyl-1,3-propanediol, 2-methyl-2,4-pentanediol, 2,2,4-trimethyl-1,3-pentanediol, 2-ethyl-1,3-hexanediol, 1,4-butanediol, 2,5-hexanediol, 1,5-pentanediol, dihydroxycyclopentane, 1,6-hexanediol, 1,4-cyclohexanediol, 4,4″-cyclohexanedimethylol, thiodiglycol, diethylene glycol, dipropylene glycol, 2-methyl-1,3-propanediol, 2-methyl-2-ethyl-1,3-propanediol, dihydroxyethyl ether of hydroquinone, hydrogenated bisphenol A, dihydroxyethyl terephthalate and dihydroxymethyl benzene and combinations thereof. Hydroxyl terminated oligomers of 1,4-butanediol terephthalate can also be used, giving a polyester-urethane-polyester repeating structure. Diamines can also be used as chain extending agents giving urea linkages. 1,4-Butanediol, 1,2-ethanediol and 1,6-hexanediol are preferred.

Apart from the above disclosure relating to the selection of the polyurethane, the most important characteristic of the thermoplastic polyurethane elastomers used herein is its soft segment glass transition temperature, abbreviated as Tg.

As reported herein, the Tg is measured by differential scanning calorimetry (“DSC”) using ISO method 11357-1/-2/-3. It has been found that, all other parameters being equal including particle size and adhesion, the lower the glass transition temperature of the soft segment of the thermoplastic polyurethane, the higher the impact resistance.

Thermoplastic compositions described herein having good impact resistance are preferably made when the soft segment glass transition temperature of the thermoplastic polyurethane is less than −20° C. Preferably, the soft segment glass transition temperature of the polyurethane should be less than −30° C. and even below −60° C. Combinations or mixtures of thermoplastic polyurethanes may also be used in the compositions of the present invention.

In the preparation of the thermoplastic polyurethanes described herein, the ratio of isocyanate to hydroxyl should be close to unity, and the reaction can be a one- or two-step reaction. Catalysts, such as hindered organic amines, for instance 1,5-diazabicyclo[4,3,0]non-5-ene (DBN), 1,4-diazabicyclo[2,2,2]octane] (DABCO™), and 1,8-diazabicyclo[5.4.0]undec-7-ene (DBU) may be used; and the reaction can be run neat or in a solvent. The syntheses of several thermoplastic polyurethanes useful in the compositions described herein appear in U.S. Pat. No. 5,286,807, incorporated herein in its entirety by reference.

Table 1 lists several specific thermoplastic polyurethanes useful as tougheners in the compositions described herein. Table 1 is not limiting as to which tougheners may be used in these compositions. Thermoplastic polyurethane tougheners are also available from commercial sources.

TABLE 1
Thermoplastic Polyurethane (TPU) compositions Useful as Toughener

| TPU | Composition (wt %) | T_{g} (° C.) |
|---|---|---|
| A | 37 ADIP, 39 BDO, 24 MDI | −35 |
| B | 60 PTMEG, 7 BDO, 33 MDI | −28 |
| C | 56 PTMEG, 8 BDO, 37 MDI | −26 |
| D | 46 ADIP, 30 BDO, 24 MDI | −20 |
| E | 35 ADIP, 35 BDO, 30 MDI | −33 |

ADIP = adipic acid,
BDO = 1,4-butanediol,
MDI = 4,4′methylene bis(phenylisocyanate).

The copolyetheramide elastomers used in the compositions described herein are elastomers composed of a polymeric hard segment (X) which is a poly(aminocarboxylic acid) or poly(lactam) having 6 or more carbon atoms or a nylon m,n polymer in which m+n is 12 or more and a polymeric soft segment (Y) which is a polyol, specifically a poly(alkylene oxide)glycol, wherein the proportion of the (X) component is 10-95% by weight, preferably 20-90% by weight.

The polymeric hard (X) segment include poly(aminocarboxylic acids) such as ω-aminocaproic acid, ω-aminoenanthic acid, ω-aminocaprylic acid, ω-aminopelargonic acid, ω-aminocapric acid, 11-aminoundecanoic acid, 12-aminododecanoic acid and the like; lactams such as caprolactam, laurolactam and the like; and nylons such as nylon 6,6, nylon 6,10, nylon 6,12, nylon 11,6, nylon 11,10, nylon 12,6, nylon 11,12, nylon 12,10, nylon 12,12 and the like.

The (Y) segment, is one or more poly(alkylene oxide)glycols, as described above, and include poly(ethylene oxide)glycol, poly(1,2-or 1,3-propylene oxide)glycol, poy(tetramethylene oxide)glycol, poly(hexamethylene oxide)glycol, an ethylene oxide-proplene oxide block or random copolymer, an ethylene oxide-tetrahydrofuran block or random copolymer, etc. Of these poly(alkylene oxide)glycols (Y), poly(ethylene oxide)glycol is particularly preferable because of its compatibility with polyoxymethylene. The number-average molecular weight of the poly(alkylene oxide)glycol (Y) is preferably 200-6,000, more preferably 250-4,000.

In the compositions described herein, the terminals of the poly(alkylene oxide)glycol (Y) may be aminated or carboxylated. An ester or an amide bond is possible between the (X) component and the (Y) component, depending upon the terminal groups of the polyamide elastomer. In bonding the (X) component to the (Y) component, a third component (Z) such as a dicarboxylic acid, a diamine or the like may used.

The dicarboxylic acid is such as to have 4-20 carbon atoms and includes, for example, aromatic dicarboxylic acids such as terephthalic acid, isophthalic acid, naphthalene-2,6-dicarboxylic acid, naphthalene-2,7-dicarboxylic acid, diphenyl-4,4-dicarboxylic acid, diphenoxyethanedicarboxylic acid, sodium 3-sulfoisophthalate and the like; alicyclic dicarboxylic acids such as 1,4-cyclohexanedicarboxylic acid, 1,2-cyclohexanedicarboxylic acid, dicyclohexyl-4,4-dicarboxylic acid and the like; aliphatic dicarboxylic acids such as succinic acid, oxalic acid, adipic acid, sebacic acid, dodecanedicarboxylic acid and the like; and their mixtures. Of these, terephthalic acid, isophthalic acid, 1,4-cyclohexanedicarboxylic acid, sebacic acid, adipic acid and dodecanedicarboxylic acid are particularly preferable in view of polymerizability, color and physical properties.

The diamine includes aromatic, alicyclic and aliphatic diamines. An example of the aliphatic diamines is hexamethylenediamine.

The copolyetherester elastomers useful as tougheners in compositions described herein are such as is disclosed in U.S. Pat. No. 3,766,146, U.S. Pat. No. 4,014,624 and U.S. Pat. No. 4,725,481. These patents disclose a segmented thermoplastic copolyetherester elastomer containing recurring polymeric long chain ester units derived from carboxylic acids and long chain glycols and short chain ester units derived from dicarboxylic acids and low molecular weight diols. The long chain ester units form the soft segment of the copolyetherester elastomer, and the short chain ester units form the hard segment.

More specifically, such copolyetherester elastomers may comprise a multiplicity of recurring intralinear long chain and short chain ester units connected head-to-tail through ester linkages, said long chain ester units being represented by the formula:

—OGO-C(O)RC(O)— (I)

and said short-chain ester units being represented by the formula:

—ODO-C(O)RC(O)— (II)

wherein:

G is a divalent radical remaining after removal of terminal hydroxyl groups from poly(alkylene oxide) glycols, as disclosed above, having a carbon to oxygen ratio of about 2.0-4.3, a molecular weight above about 400 and a melting point below about 60° C.;

R is a divalent radical remaining after removal of carboxyl groups from a dicarboxylic acid having a molecular weight less than about 300; and

D is a divalent radical remaining after removal of hydroxyl groups from a low molecular weight diol having a molecular weight less than about 250.

It is preferred that the short chain ester units constitute about 15-95% by weight of the copolyester and at least about 50% of the short chain ester units be identical.

Included among the low molecular weight diols which react to form short chain ester units are acyclic, alicyclic and aromatic dihydroxyl compounds, an example of which is 1,4-butanediol. Dicarboxylic acids which are reacted with the foregoing long chain glycols and low molecular weight diols to produce the copolyesters of this invention are aliphatic, cycloaliphatic or aromatic dicarboxylic acids of low molecular weight, that is, having a molecular weight of less than about 300, an example of which is terephthalic acid.

Examples of specific copolyetherester elastomers useful n the invention but not limited to are the Hytrel® elastomers available from E.I. du Pont de Nemours and Company, Wilmington, Del.

In reference to tougheners useful in the compositions described herein, the term “ethylene copolymer” includes polymers comprising radicals from the polymerization of ethylene and one or more other ethylenically unsaturated monomer(s) as disclosed in (ii) and (iii) below. Ethylene copolymers useful as tougheners are selected from the group consisting of:

(i) an ethylene copolymer of the formula E/X where E is the radical formed from ethylene and comprises 60-90 weight percent of the ethylene copolymer;

X is one or more radicals formed from

CH₂═CH(R¹)—C(O)—OR²

wherein R¹ is H, CH3 or C2H5, preferably H or CH3, and most preferably H; R² is an alkyl group having 1-8 carbon atoms; vinyl acetate; or a mixture thereof; and wherein X comprises 10-40 weight percent; and

(ii) an ethylene copolymer of the formula E/X/Y wherein E is the radical formed from ethylene and X is as described above, and Y is a radical formed from monomers selected from the group consisting of

CH₂═CH(R¹)—C(O)—OR³

wherein R³ is glycidyl, and R¹ is R¹ is H, CH₃ or C₂H₅; acrylonitrile; methacrylonitrile; styrene and carbon monoxide;

wherein E comprises 40-89.5 weight percent, X comprises 10-40 weight percent, and Y comprises 0.5-20 weight percent, of the ethylene copolymer.

Preferably Y is formed from glycidyl methacrylate, glycidyl acrylate and carbon monoxide. Preferably X comprises 15-35 wt %, and most preferably 20-35 wt % of the ethylene copolymer, and Y comprises 0.5-20 wt %, preferably 2.0-12 wt %, and most preferably 3-8 wt %, of the ethylene copolymer.

The toughener may be E/X, wherein X is vinyl acetate, and is present at 40 wt % based on the total weight of the E/X polymer. E/X polymers are commercially available. For instance, Elvax® ethylene/vinyl acetate polymers are suitable for the invention and are available from E.I. du Pont de Nemours and Company, Wilmington, Del.

The ethylene copolymers used in the compositions described herein are random copolymers that can be prepared by direct polymerization of the foregoing monomers in the presence of a free-radical polymerization initiator at elevated temperatures, about 100 to about 270° C. or about 130 to about 230° C., and at elevated pressures, at least about 70 MPa or about 140 to about 350 MPa. The ethylene copolymers may also be prepared using a tubular process, an autoclave, or a combination thereof, or other suitable processes. The ethylene copolymers may be not fully uniform in repeat unit composition throughout the polymer chain due to imperfect mixing during polymerization or variable monomer concentrations during the course of the polymerization. The ethylene copolymers are not grafted or otherwise modified post-polymerization.

Cellulose esters useful in the compositions of the invention have a glass transition of between 100 and 225° C., preferably 125 to 200° C., and most preferably 150 to 200° C.; as determined with differential scanning calorimetry at 10° C./minute scan rate, at the mid-point of the glass transition. Preferably the cellulose ester is noncrystalline, that is, has no crystalline melting endotherm observable with DSC. Generally, the cellulose ester should have an average of at least about 0.5 out of 3 available hydroxyl groups remaining unesterified. The cellulose esters are derived from esterification of cellulose with organic acids. Preferably the acid component contains 2-6 carbon atoms, and preferably no more than 4 carbon atoms. The degree of esterification is preferably no more than 2.5, and desirably no greater than 2.4. Preferred cellulose ester(s) are selected from the group consisting of cellulose acetate, cellulose propionate, cellulose butyrate; and mixtures thereof. In one embodiment the cellulose ester has an acetyl content of between 30 and 40 wt %, based on the total weight of cellulose acetate.

Specific examples of cellulose esters useful in the present invention include Tenite® CAB 381-20 and Tenite® CAB 171-15, cellulose butyrate esters; Tenite® CAP 482-20, a cellulose propionate ester; Tenite® CA 398-30, Tenite® CA 398-10, and Tenite® CA 398-3, cellulose acetate resins; all available from Eastman Chemical Co., Kingsport, Tenn.

Preferably the compositions comprise polyacetal homopolymer, copolymer, or combination thereof; in about 87 to about 40% by weight; cellulose ester in about 10 to about 60% by weight; and the toughener in about 3 to about 15% by weight, based on the total weight of the composition. One of skill in the art would comprehend that the compositions described herein include compositions containing polyoxymethylene, cellulose ester, and toughener in the above-stated proportions and also compositions containing other ingredients, modifiers and/or additives including polyamide stabilizers such as those disclosed in U.S. Pat. Nos. 3,960,984 and 4,098,843; anti-oxidants, pigments, colorants, carbon black, reinforcing agents and fillers; provided that the above-stated relative proportions of the polyoxymethylene, cellulose ester and toughener are maintained. The thermoplastic composition may consist essentially of polyacetal homopolymer, copolymer, or mixture thereof; in 70 to 30% by weight; cellulose ester in 40 to 60% by weight; and the toughener in 10 to 15% by weight, based on the total weight of the thermoplastic composition.

Any intensive mixing device capable of developing high shear at temperatures above the melting points of the ingredients can be used to disperse the polyurethane in the polyoxymethylene. Examples of such devices include rubber mills, internal mixers such as “Banbury” and “Brabender” mixers, single or multiblade internal mixers with a cavity heated externally or by friction, “Ko-kneaders”, multibarrel mixers such as “Farrel Continuous Mixers”, injection molding machines, and extruders, both single screw and twin screw, both co-rotating and counter rotating. These devices can be used alone or in combination with static mixers, mixing torpedos and/or various devices to increase internal pressure and/or the intensity of mixing such as valves, gates or screws designed for this purpose. Continuous devices are preferred. Twin screw extruders are especially preferred, particularly those incorporating high intensity mixing sections such as reverse pitch elements and kneading elements.

The compositions described herein are useful as injection molding materials and blow molding materials with improved heat resistance. Specific articles made with the compositions include housings, gear sprockets and other mechanical articles that operate above room temperature.

### Materials

Melting points (Tₘ) and glass transitions (T_{g}) of all materials were as measured by DSC, 10° C./min, using Test method ISO method 11357-1/-2/-3;

melt index of all materials were measured at 190° C., 2.16 Kg load, using ISO method 1133; heat distortion temperature (HDT) were measured at 1.80 MPa stress, using ISO method 75-1/-2; unless otherwise stated.

Resin A refers to Delrin® 100P, a polyoxymethylene having a Tₘ of 178° C.; a melt index of 2.5 g/10 min; and HDT of 93° C.

Resin B refers to a 60/40 wt ratio of a hand mixed blend of Delrin® 10 and Delrin® 1700P. Delrin® 10 is a polyoxymethylene having a melt index of about 0.2 g/10 min or less. Delrin® 1700P is a polyoxymethylene having a Tₘ of 178° C. (DSC, 10° C./min, Test method ISO method 1346 C), a melt index of 37 g/10 min and HDT of 105° C.

Resin C refers to Delrin® 500P, a polyoxymethylene having a Tₘ of 178° C., a melt index of 15 g/10 min and HDT of 94° C.

Resin D refers to Delrin® 460, a polyoxymethylene having a Tₘ of 168° C., a melt index of 9 g/10 min, and HDT of 92° C.

The Delrin® resins are available from E.I. du Pont de Nemours and Company, Wilmington, Del.

EBAGMA-12 was an ethylene/n-butyl acrylate/glycidyl methacrylate terpolymer derived from 66 weight % ethylene, 22 weight % n-butyl acrylate, and 12 weight % glycidyl methacrylate. It had a melt index of 8 g/10 minutes as measured by ASTM method D1238.

Elvax® 40W is an ethylene vinyl acetate, 60/40 ratio by weight, copolymer available from E.I. du Pont de Nemours and Company, Wilmington, Del.

Hytrel® 3078 is a polyetherpolyester elastomer [Tₘ 177° C. and T_{g} −60° C. (10° C./min, ISO 11357-1/-2/-3)] available from E.I. du Pont de Nemours and Company, Wilmington, Del.

Elvaloy® EP4015 is an ethylene/butyl acrylate/carbon monoxide 60/30/10 by weight terpolymer having a melt index 12 g/10 min (190° C., 2.16 Kg, ISO method 1133) available from E.I. du Pont de Nemours and Company, Wilmington, Del.

PEBAX® 1657 copolyetheramide has a poly(ethylene) glycol as a polyether component and nylon 6 as a polyamide segment at about 1:1 wt ratio and is available from Atochem Co.

CA refers to Tenite® CA 398-3 cellulose acetate, having an acetyl content of 39.8 wt %, a melting point of 230-250° C., and T_{g} of 180° C.; available from Eastman Chemical Co., Kingsport Tenn.

Texin® 285 is an aromatic polyester based polyurethane having a T_{g} of −44 F (−42° C., using Dynamic Mechanical Analysis) available from Bayer Material Science, Pittsburgh, Pa.

Irganox® 1010 antioxidant was purchased from Ciba Specialty Chemicals (Tarrytown, N.Y., USA).

Superflex® 200 is a precipitated calcium carbonate available from Pfizer Inc.

### Methods

Compounding

### Examples 1-6

The mixing device used in all of the examples, unless noted otherwise, was a 9 barrel 30 mm Werner & Phleider co-rotating twin screw extruder fitted with a screw containing three sets of kneading blocks followed by a reverse element was heated with barrel 2 set at 210° C., and the rest set at 225° C. A vacuum port was placed at barrel 8 near the die. The extruder was run at 200 rpm and sample rate was 30 pounds (13.6 Kg) per hour. The cellulose ester was fed from one feeder and a combination of polyacetal and rubber pellets from the other. Irganox® 1010 antioxidant, 0.2 wt % based on the total weight of the composition, was added to each formulation as a stabilizer. A nitrogen atmosphere was maintained on the rear feed zone. Samples were dried in a vacuum oven overnight at 90° C. under a low nitrogen sweep.

### Examples 7-12

The barrels were heated as in Examples 1-6, and run at 150 rpm. Example 7 and 9 were run at 20 lbs. (9.09 Kg) per hour; the others run at 30 pounds (13.6 Kg) per hour.

### Examples 13-17

All barrels were heated to 210° C. Examples 13-15 were done at 40 lbs (18.2 Kg) per hour and Examples 16 and 17 were run at 30 lbs. (13.6 Kg) per hour. In Example 17 the extruder was run at 150 rpm instead of the standard 200 rpm.

### Molding

Injection molding was carried out using an Arburg reciprocating screw molding machine model number 221K, having a 38 ton clamping pressure and 1.5 oz. shot size (polystyrene). A two cavity mold with a ⅛″ ASTM flex bar and a ⅛″ ASTM tensile bar was used. The temperatures were set at 180° C. rear, 190° C. mid-section, and 200° C. for the front and nozzle.

Examples 1-6, mold temperature was 102° C. and a 35 second injection and 15 second cooling cycle was used.

Examples 7-12, temperatures were set at 190° C. rear, 195° C. mid-section, and 205° C. for the front and nozzle; a mold temperature was 100° C. and a 35 second injection and 15 second cooling cycle was used.

Examples 13-15, mold temperature was 90° C. and a 35 second injection and 10 second cooling cycle was used.

Examples 16-17, mold temperature was 92° C. and a 35 second injection and 13 second cooling cycle was used.

### Testing

The heat deflection temperature (HDT) in the Tables was determined using the procedure set forth in ASTM D-648. The results listed in Table 2 indicate that a POM exhibits improved HDT when compounded with cellulose esters and a variety of tougheners, versus the comparative example A.

TABLE 2
HDT of POM Compositions^{a} with Cellulose acetate (CA)

| | Examples | | | | | | |
|---|---|---|---|---|---|---|---|
| Materials | Comp. A | 1 | 2 | 3 | 4 | 5 | 6 |
| Resin A | 100 | 70 | 70 | 70 | 70 | 70 | 70 |
| Texin ® 285 | | 10 | | | | | |
| EBAGMA-12 | | | 10 | | | | |
| EP 4015 | | | | 10 | | | |
| Elvax ® 40W | | | | | 10 | | |
| Hytrel ® 3078 | | | | | | 10 | |
| PEBAX ® 1657 | | | | | | | 10 |
| CA | | 20 | 20 | 20 | 20 | 20 | 20 |
| HDT^{b} (° C.) | 94 | 117 | 120 | 119 | 120 | 117 | 118 |

^{a}parts by weight; 0.2 wt % additional Irganox ® 1010 stabilizer added to all formulations
^{b}ASTM D-648 264 psi.

The results listed in Table 3 indicate that a blend of POMs exhibit improved HDT when compounded with cellulose esters, and the results can vary to some extent with mixing conditions. Example 12 shows that some additives, for instance calcium carbonate, can have a negative impact on the HDT. The results listed in Table 3 indicate that higher levels of cellulose ester can significantly increase HDT.

TABLE 3
HDT of POM Compositions^{a} with Cellulose acetate (CA)

| | Examples | | | | | | |
|---|---|---|---|---|---|---|---|
| | Comp. | | | | | | |
| Materials | B | 7 | 8 | 9 | 10 | 11 | 12 |
| Resin B | 100 | 70 | 70-SF^{c} | 70 | 70-SF | 70 | 55 |
| Texin ® 285 | — | 10 | 10 | 10-SF | 10-SF | 7 | 10 |
| EBAGMA-12 | — | — | — | — | — | 3 | 5 |
| Superflex 200 | — | — | — | — | — | — | 10 |
| CA | — | 20 | 20 | 20 | 20 | 20 | 20 |
| HDT^{b} (° C.) | 109 | 112 | 117 | 118 | 116 | 117 | 92 |

^{a}parts by weight; 0.2 wt % additional Irganox ® 1010 stabilizer added to all formulations
^{b}ASTM D-648 264 psi
^{c}SF refers to side-fed into extruder.

TABLE 4
HDT of POM Compositions^{a} with Cellulose acetate (CA)

| | Comp. | Comp. | | | | | |
|---|---|---|---|---|---|---|---|
| | C | D | 13 | 14 | 15 | 16 | 17 |
| Resin C | 100 | — | 76 | 76 | — | — | — |
| Resin D | — | 100 | — | — | — | 57 | 57 |
| Texin ® 285 | — | — | — | — | 4 | — | — |
| EP 4015 | — | — | 4 | — | — | 3 | 3 |
| EBAGMA- | — | — | — | 4 | — | — | — |
| 12 | | | | | | | |
| CA | — | — | 20 | 20 | 20 | 40-SF | 40-SF |
| HDT^{b} (° C.) | 106 | 107 | 116 | 122 | 113 | 132 | 137 |

^{a}parts by weight; 0.2 wt % additional Irganox ® 1010 stabilizer added to all formulation
^{b}ASTM D-648 264 psi
^{c}SF refers to side-fed into extruder.

What is claimed is:

1. A thermoplastic composition comprising:
a) 87 to 30 weight percent of a polyacetal homopolymer or of a polyacetal copolymer, or of a combination of these;
b) 10 to 60 weight percent of one or more cellulose ester(s) of C1 to C6 alkyl carboxylic acids; and
c) 3-15 weight percent of at least one toughener, wherein each weight percent is based on the total weight of the thermoplastic composition.

2. The composition of claim 1, wherein the toughener is selected from the group consisting of:
i) a thermoplastic elastomer selected from the group consisting of thermoplastic polyurethane, copolyetheramide, and copolyetherester and having a soft segment glass transition temperature of less than −20° C.;
ii) an ethylene copolymer of the formula E/X,
wherein E comprises 60-90 weight percent, and X comprises 10-40 weight percent, of the ethylene copolymer;
iii) an ethylene copolymer of the formula E/X/Y,
wherein E comprises 40-89.5 weight percent, X comprises 10-40 weight percent, and Y comprises 0.5-20 weight percent, of the ethylene copolymer,
and a combination of these,
wherein
E is the radical formed from ethylene,
X is one or more radicals formed from CH₂═CH(R¹)—C(O)—OR²,
wherein R¹ is H, CH₃ or C₂H₅, (preferably H or CH₃, and most preferably H)R² is an alkyl group having 1-8 carbon atoms, vinyl acetate or a combination of these, and
Y is a radical formed from monomers selected from the group consisting of CH₂═CH(R¹)—C(O)—OR³,
wherein R³ is glycidyl, and R¹ is R¹ is H, CH₃ or C₂H₅, acrylonitrile, methacrylonitrile, styrene, and carbon monoxide.

3. The composition of claim 1, wherein the one or more cellulose ester is selected from the group consisting of cellulose acetate, cellulose propionate, cellulose butyrate, and a combination of these.

4. The composition of claim 1, wherein the one or more cellulose ester has a glass transition of between 100 and 225° C.

5. The composition of claim 1, wherein the polyacetal is a homopolymer.

6. The composition of claim 1, wherein the polyacetal has a number average molecular weight of from 20,000 to 100,000.

7. The composition of claim 1, wherein the polyacetal has a melt flow rate of 0.1 to 10.0 grams/10 minutes.

8. The composition of claim 1, wherein the polyacetal is a copolymer derived from copolymerization of a comonomer selected from the group consisting of alkylene oxides of 2-12 carbon atoms.

9. An article made from the composition of claim 1.

10. The article of claim 9 comprising a housing or a sprocket.
